(19) United States
(12) Patent Application Publication
(10) Pub. No.: US 2007/0156336 A1
(43) Pub. Date: Jul. 5, 2007

(54) METHOD FOR AUTOMATICALLY PROMPTING DETOUR

(75) Inventors: Chien-Yang Chang, Taoyuan County (TW); Shu-Ling Chen, Yilan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: MITAC INTERNATIONAL CORP., Taoyuan (TW)

(21) Appl. No.: 11/554,579

(22) Filed: Oct. 30, 2006

(30) Foreign Application Priority Data
Jan. 4, 2006 (TW) 95100312

(51) Int. Cl. G01C 21/00

(52) U.S. Cl. 701/210; 701/201

(57) ABSTRACT

A method for automatically prompting a detour is disclosed. When a user drives slowly because of heavy traffic, a navigation device automatically prompts the user to tale a detour. The method includes the following steps. First, the navigation device calculates its moving speed according to its navigation signal. Then, the navigation device begins to count the time when the moving speed is smaller than a predetermined speed. When the moving speed is continuously smaller than the predetermined speed and the counted time exceeds a predetermined time, the navigation device prompts a message asking whether to plan a new route.

### CROSS-REFERENCE TO RELATED APPLICATION

This application claims the priority benefit of Taiwan application serial no. 95100312, filed on Jan. 4, 2006. All disclosure of the Taiwan application is incorporated herein by reference.

### BACKGROUND OF THE INVENTION

1. Field of the Invention

The present invention relates to a method of planning driving route, and more particularly, to a method for automatically prompting a detour.

2. Description of Related Art

Global position system (GPS) is a navigation device that combines satellite and wireless technologies to provide a precise location, speed and time to a user. As a result of the advance in satellite communication technologies, many applications of GPS have found a big market. Business opportunities for using GPS technology also spring up everywhere. GPS technology is no longer confined, as in the earlier days, to the military units for accurately positioning targets such as warplanes, warships, military vehicles, personnel or specific targets for attack. Nowadays, GPS technologies have opened up to civilian use for finding precise positions. This technology that combines space satellite and communication techniques expands rapidly in the civilian market and some of its applications even revolutionize our lifestyle. For example, cars or ships in motion can estimate the arrival time and plan the route to a destination through the GPS; an emergency ambulance can accomplish a life-saving mission effectively; and, vehicle driver can find its current position and a route to a target destination through an electronic map.

GPS satellite automatic vehicle guidance system (AVGS) utilizes GPS satellite navigating and positioning technique with an antenna installed in the vehicle to link up with a geographical information system (GIS) database whose information can be displayed on a computer screen inside the vehicle. The GPS AVGS serves as a direction guide to the vehicle driver and permits the user to select the best or fastest driving route to a destination.

However, sometimes the user of the GPS AVGS follows a pre-planned route, heavy traffic or unforeseeable circumstances somewhere along the route may stall the vehicle. The driver is forced to wait for the conditions to improve because the system does not automatically provide the driver with information regarding any alternative routes to the destination. Hence, the driver has to idly wait and waste precious time and energy on the road.

### SUMMARY OF THE INVENTION

Accordingly, at least one objective of the present invention is to provide a method for automatically prompting a detour. By detecting the driving speed and accumulating the time when the driving speed is below a predetermined value, a message prompting the user to plan a new route can be activated at an appropriate moment so that the time wasted on waiting in heavy traffic or driving under bad road conditions is minimized.

To achieve these and other advantages and in accordance with the purpose of the invention, as embodied and broadly described herein, the invention provides a method for automatically prompting a detour. The method includes the following steps. First, the navigation device calculates its moving speed according to its navigation signal. Then, the navigation device begins to count the time when the moving speed is smaller than a predetermined speed. When the moving speed is continuously smaller than the predetermined speed and the counted time exceeds a predetermined time, the navigation device prompts a message asking whether to plan a new route.

According to the foregoing method of automatically prompting a detour in the preferred embodiment of the present invention, the counting of time when the moving speed is smaller than a predetermined speed further includes restarting the counting whenever the moving speed is greater than or equal to the predetermined speed.

According to the foregoing method of automatically prompting a detour in the preferred embodiment of the present invention, the prompting of a message asking whether to plan a new route further includes determining if there is a road junction at a predetermined distance ahead. If there is a road junction ahead, then a message asking whether to plan a new route is prompted. On the contrary, if there is no road junction within a predetermined distance ahead, the counting of time is continued.

The present invention deploys a method of automatically prompting a detour. Through the detection of the moving speed and the counting of time, the user is prompted to consider an alternative route instead of waiting idly when there is heavy traffic or unforeseen conditions on the planned route so that a more personalized routing can be provided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps in the method of automatically prompting a detour according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

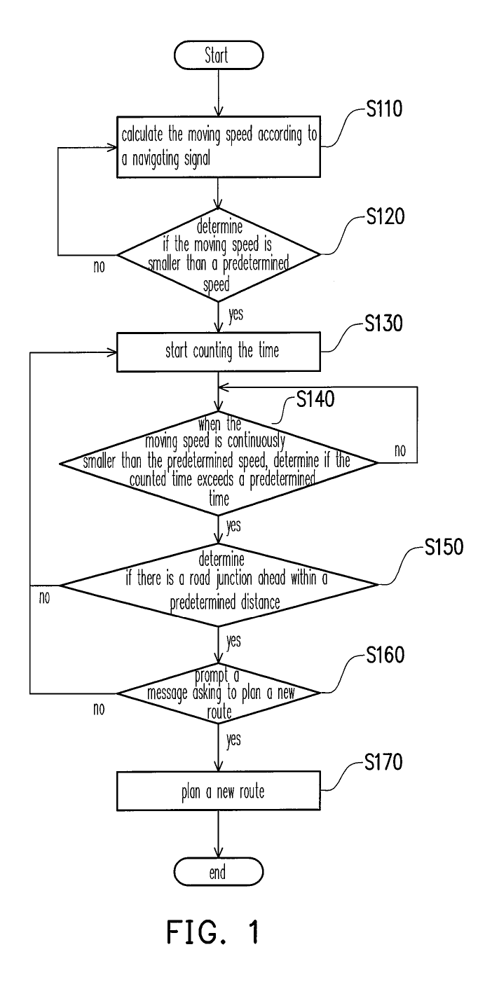

FIG. 1 is a flow diagram showing the steps in the method of automatically prompting a detour according to one preferred embodiment of the present invention. The embodiment is suitable for a navigation device that is moving forward according to a route.

When the user triggers a navigation device, the navigation device calculates its moving speed according to its navigation signal (step S110). Then, the navigation device detects whether its moving speed is below a predetermined speed (for example, 10 km/hour) (step S120). When the moving speed of the navigation device is smaller than the predetermined speed, the possibility of the user encountering heavy traffic or bad roadside conditions is assumed. Therefore, the navigation device starts counting the time (step S130). However, if the moving speed is greater than or equal to the predetermined speed, the moving speed detection is continued.

While counting the time, when the moving speed of the navigation device continues to be smaller than the predetermined speed, it is monitored to determine if the counted time exceeds a predetermined time (for example, 10 minutes) (step S140). In the meantime of counting the time, if the moving speed is increased to a value equal to or greater than the predetermined speed, an improved road condition is implied. Hence, the navigation device restarts the counting of time (step S130).

If the counted time is smaller than the predetermined time, the accumulation of time is continued. When the counted time exceeds the predetermined time, the navigation device determines if there is a road junction within a predetermined distance (for example, 100 meters) ahead that can be used for a detour (step 150) to prevent the user from waiting on the originally planned route. According to the result in step S150, if there is no road junction ahead for a detour, the counting of time is continued until a road junction at the next point allowing a detour is found.

On the contrary, if there is a road junction for detour ahead, a message prompting the user to plan a new route is issued (step S160). Then, according to the user's free will, the user can choose to plan a new route or not. If the user chooses to consider a new route, the navigation device uses the road junction as a new starting point to plan a new route (step S170). If the user chooses not to follow a detour, the navigation device cancels the planning of a new route but continues counting the time.

In the foregoing embodiment, the method of prompting a message asking for planning a new route includes displaying the prompting message or outputting the prompting message vocally. However, the scope is not limited as such because the user can select either one of them. In addition, the predetermined speed of 10 km/hour, the predetermined time of 10 minutes and the predetermined distance of 100 meters mentioned in the present embodiment are suggestions only and should by no means limit the scope of the present invention.

In summary, the present invention deploys a method of automatically prompting a detour. The user is prompted to consider an alternative route instead of waiting idly when there is heavy traffic or unforeseen conditions on the planned route. This personalized route planning method not only avoids painful waiting on a pre-planned route, but also saves the user's considerable time and energy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of automatically prompting a detour, suitable for an navigation device that is moving forward according to a route, comprising:
calculating a moving speed of the navigation device according to a navigating signal of the navigation device;
counting the time when the moving speed is smaller than a predetermined speed; and
prompting a message asking for planning a new route when the moving speed is continuously smaller than the predetermined speed and the counted time exceeds a predetermined time.

2. The method of claim 1, wherein, when the moving speed is smaller than the predetermined speed, the counting of time further comprises:
re-starting the counting of time when the moving speed increases to a value greater than or equal to the predetermined speed.

3. The method of claim 1, wherein the step of prompting a message asking to plan a new route comprises:
determining if there is a road junction within a predetermined distance ahead;
if there is a road junction, a message asking to plan a new route is prompted; and
if there is no road junction ahead, the step of counting the time is continued.

4. The method of claim 3, wherein, after prompting a message asking to plan a new route, further comprises:
if planning a new route is selected, then a new route is planned using the road junction as a starting point; and
if planning a new route is not selected, then the step of counting the time is continued.

5. The method of claim 1, wherein the method of prompting a message asking to plan a new route comprises displaying the prompt message or outputting the prompt message vocally.

6. The method of claim 1, wherein the predetermined speed comprises 10 km/hour.

7. The method of claim 1, wherein the predetermined time comprises 10 minutes.

8. The method of claim 1, wherein the predetermined distance comprises 100 meters.
